(19) United States
(12) Patent Application Publication
(10) Pub. No.: US 2005/0120182 A1
(43) Pub. Date: Jun. 2, 2005

(54) Method and apparatus for implementing cache coherence with adaptive write updates

(76) Inventors: Michael J. Koster, Fremont, CA (US); Brian O'Krafka, Austin, TX (US); Roy S. Moore, Georgetown, TX (US)

Correspondence Address: A. RICHARD PARK, REG. NO. 41241;PARK, VAUGHAN & FLEMING LLP, 2820 FIFTH STREET, DAVIS, CA, 95616, US

(21) Appl. No.: 10/726,787

(22) Filed: Dec. 2, 2003

(51) Int. Cl. G06F 12/00

(52) U.S. Cl. 711/141; 711/133

(57) ABSTRACT

One embodiment of the present invention provides a system that facilitates cache coherence with adaptive write updates. During operation, a cache is initialized to operate using a write-invalidate protocol. During program execution, the system monitors the dynamic behavior of the cache. If the dynamic behavior indicates that better performance can be achieved using a write-broadcast protocol, the system switches the cache to operate using the write-broadcast protocol.

### BACKGROUND

1. Field of the Invention

The present invention relates to the design of multiprocessor-based computing systems. More specifically, the present invention relates to a method and an apparatus that facilitates cache coherence using adaptive write updates.

2. Related Art

In order to achieve high rates of computational performance, computer system designers are beginning to employ multiple processors that operate in parallel to perform a single computational task. One common multiprocessor design includes a number of processors 151-154 coupled to level one (L1) caches 161-164 that share a single level two (L2) cache 180 and a memory 183 (see FIG. 1). During operation, if a processor 151 accesses a data item that is not present in local L1 cache 161, the system attempts to retrieve the data item from L2 cache 180. If the data item is not present in L2 cache 180, the system first retrieves the data item from memory 183 into L2 cache 180, and then from L2 cache 180 into L1 cache 161.

Note that coherence problems can arise if a copy of the same data item exists in more than one L1 cache. In this case, modifications to a first version of a data item in L1 cache 161 may cause the first version to be different than a second version of the data item in L1 cache 162.

In order to prevent such coherency problems, computer systems often provide a coherency protocol that operates across bus 170. A coherency protocol typically ensures that if one copy of a data item is modified in L1 cache 161, other copies of the same data item in L1 caches 162-164, in L2 cache 180 and in memory 183 are updated or invalidated to reflect the modification.

Coherence protocols typically perform invalidations by broadcasting invalidation messages across bus 170. However, as multiprocessor systems get progressively larger and faster, such invalidations occur more frequently. Hence, these invalidation messages can potentially tie up bus 170, and can thereby degrade overall system performance.

The most commonly used cache coherence protocol is the “write-invalidate” protocol. In the write-invalidate protocol, whenever a cache line is updated in a local cache, an invalidation signal is sent to other caches in the multiprocessor system to invalidate other copies of the cache line that might exist. This causes that cache line to be reloaded by the other processors before it is accessed again.

The write-invalidate protocol works well for many types of applications. However, it is relatively inefficient in cases where a large number of processors perform accesses (including write operations) to a small number of caches blocks. For example, a cache line containing a lock may be simultaneously written to by a large number of processors. This causes the cache line to “ping pong” between caches. When the cache line is invalidated, all of the other processor that need to access the cache line must reload the line into their local caches, which can cause serious contention problems on the system bus.

It is possible to partially mitigate this problem by modifying software, for example, to write to locks as infrequently as possible, or to not put locks in the same cache line. However, software modifications cannot eliminate the problem; they can only reduce the problem in some situations.

An alternative protocol, known as the “write-broadcast” protocol, which broadcasts updates to cache lines, instead of simply sending an invalidation signal. For cache lines that are frequently accessed by multiple processors, a write-broadcast protocol is generally more efficient because the update only has to be broadcast once. Whereas, after an invalidation signal has been sent, processors that invalidated the cache line have to reload the cache line before they can access it again, which can seriously degrade system performance.

Unfortunately, the write-broadcast protocol requires updates to be broadcast during every write to a cache line. In a large multiprocessor system, where many processors can potentially perform write operations at the same time, this can cause serious performance problems on the system bus. Moreover, the write-broadcast protocol provides no advantage for the majority of cache lines that are not frequently accessed by a large number of processors.

Hence, what is needed is a method and an apparatus that implements a cache coherence protocol without the above described performance problems.

### SUMMARY

One embodiment of the present invention provides a system that facilitates cache coherence with adaptive write updates. During operation, a cache is initialized to operate using a write-invalidate protocol. During program execution, the system monitors the dynamic behavior of the cache. If the dynamic behavior indicates that better performance can be achieved using a write-broadcast protocol, the system switches the cache to operate using the write-broadcast protocol.

In a variation of this embodiment, monitoring the dynamic behavior of the cache involves monitoring the dynamic behavior of the cache on a cache-line by cache-line basis.

In a further variation, switching to the write-broadcast protocol involves switching to the write-broadcast protocol on a cache-line by cache-line basis.

In a further variation, monitoring the dynamic behavior of the cache involves maintaining a count for each cache line of the number of cache line invalidations the cache line has been subject to during program execution.

In a further variation, if the number of cache line invalidations indicates that a given cache line is updated frequently, the cache line is switched to operate using the write-broadcast protocol.

In a further variation, if the given cache line is operating under the write-broadcast protocol and the number of cache line updates indicates that the given cache line is not being contended for by multiple processors, the cache line is switched to operate under the write-invalidate protocol.

In a further variation, if the shared memory multiprocessor includes modules that are not able to switch to the write-broadcast protocol, the system locks the cache into the write-invalidate protocol.

Note that the write-invalidate protocol sends an invalidation message to other caches in a shared memory multiprocessor when the given cache line is updated in a local cache.

In contrast, the write-broadcast protocol broadcasts an update to other caches in a shared memory multiprocessor when the given cache line is updated in a local cache.

### BRIEF DESCRIPTION OF THE FIGURES

FIG. 1 illustrates a multiprocessor system in accordance with an embodiment of the present invention.

FIG. 2 illustrates a single processor 151 from multiprocessor system 100 in FIG. 1 in accordance with an embodiment of the present invention.

FIG. 3A presents a state diagram for a cache in accordance with an embodiment of the present invention.

FIG. 3B presents a table of transitions for the state machine of FIG. 2A in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Multiprocessor System

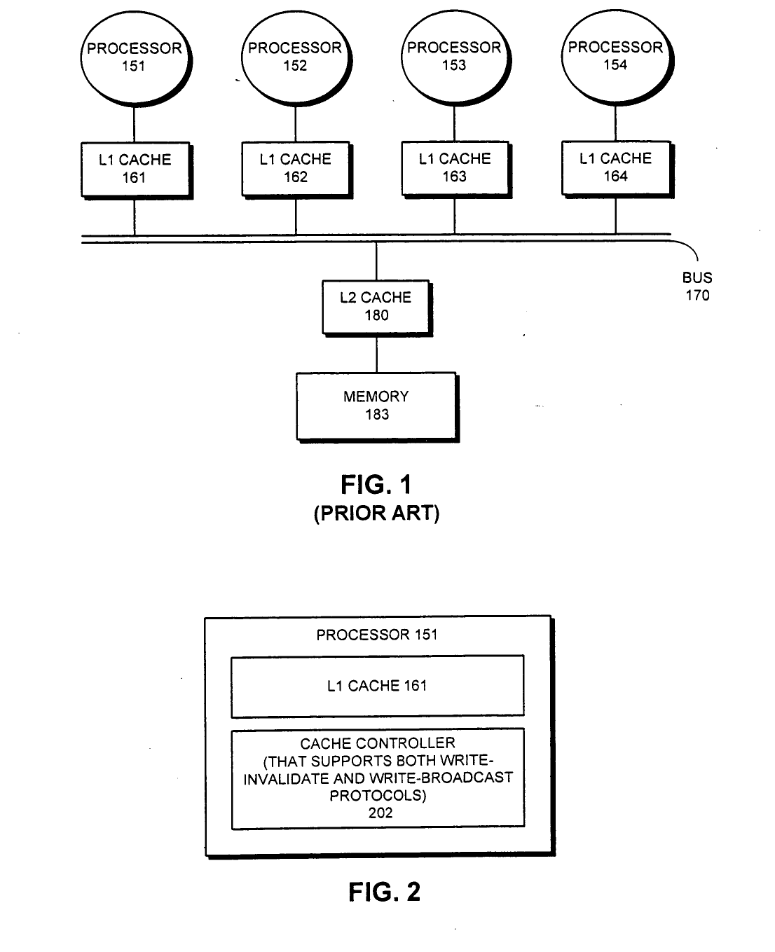

The present invention operates on a multiprocessor system similar to the multiprocessor system illustrated in FIG. 1, except that the multiprocessor system has been modified to support both write-invalidate and write-update cache coherence protocols. Within this modified multiprocessor system, processors 151-154 can generally include any type of processor, including, but not limited to, a microprocessor, a digital signal processor, a personal organizer, a device controller, and a computational engine within an appliance. Memory 183 can include any type of memory devices that can hold data when the computer system is in use. This includes, but is not limited to, RAM, ROM, EPROM, EEPROM, flash memory, magnetic storage, optical storage, and battery-backed-up RAM. Bus 170 includes any type of bus capable of transmitting addresses and data between processors 151-154 and L2 cache 180.

Processor

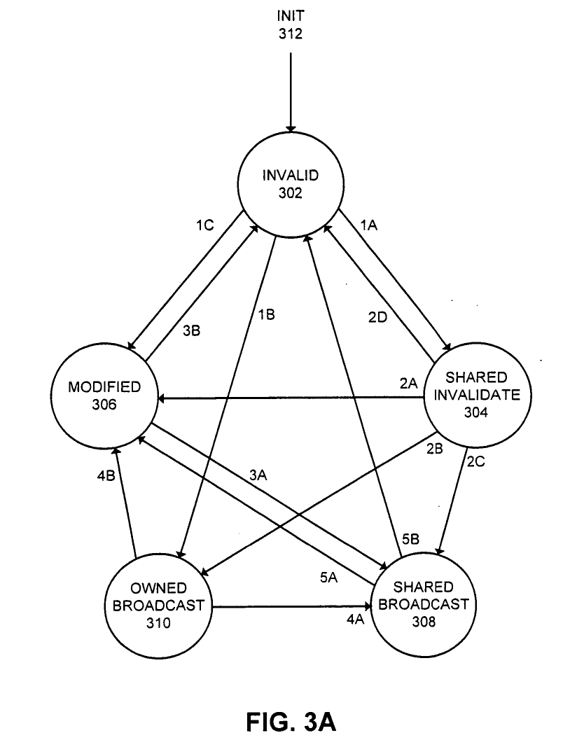

FIG. 2 illustrates a single processor 151 from multiprocessor system 100 in FIG. 1 in accordance with an embodiment of the present invention. Processor 151 includes L1 cache 161 and cache controller 202.

During operation, L1 cache 161 receives cache lines from L2 cache 180 under control of cache controller 202. A cache line typically includes multiple bytes (64 and 128 bytes are common) of data that are contiguous in shared memory 102. When processor 151 requests a data item that is not currently in the L1 cache 161, the corresponding cache line is loaded into L1 cache 161. If there is no vacant slot for a cache line available within L1 cache 161, a cache line needs to be evicted from L1 cache 161 to make room for the new cache line.

Cache controller 202 controls the loading and eviction of cache lines within L1 cache 161. Additionally, cache controller 202 is responsible for ensuring cache coherency among the caches within processors 151-154.

Initially, cache controller 202 is configured to use a write-invalidate protocol to ensure cache coherency. During an update to a data item in L1 cache 161, the write-invalidate protocol broadcasts an invalidate signal, which causes copies of the same cache line to be invalidated in other caches in multiprocessor system 100. This protocol is advantageous when cache lines are not being accessed frequently in different caches of multiprocessor system 100. However, if a given cache line is accessed frequently, the write-invalidate protocol causes excessive contention on bus 170. In this case, cache controller 202 switches to a write-broadcast protocol. Cache controller 202 can detects that a cache line is being repeatedly updated by different processors by using a counter to count the number of updates to the cache line.

State Machine and State Diagram

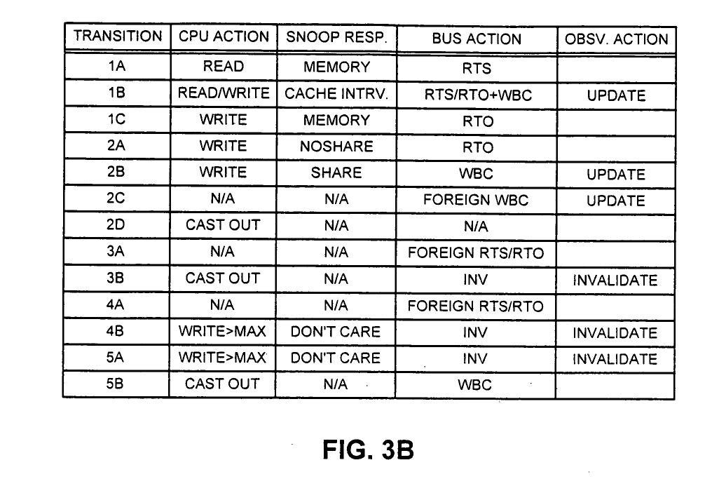

FIG. 3A presents a state diagram for a cache line in accordance with an embodiment of the present invention. Note that cache controller 202 implements the protocol specified by the state diagram presented in FIG. 3A. FIG. 3B presents a corresponding table of transitions for the state machine of FIG. 3A in accordance with an embodiment of the present invention. These transitions completely describe the operation of the state machine of FIG. 3A. The abbreviations used in this table include read-to-share (RTS), read-to-own (RTO), write broadcast (WBC) and invalidate (INV). The term “foreign” indicates that the transition is triggered by another “foreign” cache accessing the same cache line.

Referring to FIG. 3A, a cache line starts in the invalid state 302. When a processor reads the cache line invalid state 302, the processor first performs an RTS operation across the system bus, which pulls the cache line into the processor's local cache to allow the processor to read the cache line. The system also moves the cache line into the shared-invalidate 304 state across transition 1A. Note that in the shared-invalidate state, multiple caches may contain the cache line.

When a processor reads or writes to a cache line that is in invalid state 302, and if another processor provides the cache line through a cache intervention operation, the cache line is likely to be ping-ponging between caches. Hence, in this case the cache line is moved into the owned-broadcast state 310 across transition 1B. The system also performs an RTO operation (for a read) or an RTS operation (for a write) across the system bus, and then performs a WBC operation.

When a processor writes to a cache line in invalid state 302, the processor first performs an RTO operation across the system bus, which pulls the cache line into the processor's local cache to allow the processor to write to the cache line. The system also moves the cache line into the modified 304 state across transition 1C.

When the cache line is in shared-invalidate state 304 and the processor needs to write to the cache line, and the cache line is not shared by other processors, the processor performs an RTO on the system bus, which invalidates the cache line in other caches. The system also moves the cache line into modified state 306 across transition 2A. At this point, processor 106 is free to update the cache line.

When the cache line is in shared-invalidate state 304 and the processor needs to write to the cache line, and the cache line is shared by other processors, the processor performs a WBC on the system bus, which updates the cache line in other caches. The system also moves the cache line into owned-broadcast state 310 across transition 2B.

When the cache line is in shared-validate state 304 and the processor receives a foreign WBC directed to the cache line, the cache line is updated with the broadcast value. The system also moves the cache line into shared broadcast state 306 across transition 2C.

When the cache line is in shared-invalidate state 304, and the cache line is invalidated by another processor performing an RTO on the cache line (or is otherwise cast out of cache) the system moves the cache line into invalid state 302 as is indicated by transition 2D.

When the cache line is in modified state 306 and if a foreign RTO or RTS takes place on the cache line, the system moves the cache line into shared-broadcast state 308 across transition 3A. When the cache line is in shared-broadcast state 308, subsequent updates to the cache line cause a broadcast of the update to be sent to other caches instead of sending an invalidate signal.

When the cache line is in modified state 306, the processor can cast the cache line out of cache and write the cache line back to memory. This moves the cache line back into the invalid state 302 across transition 3B.

When the cache line is in the owned-broadcast state 310, and if a foreign RTO or RTS takes place on the cache line, the system moves the cache line into shared-broadcast state 308 across transition 4A.

When the cache line is in the owned-broadcast state 310, and if a the processor wants to write the cache line, and furthermore the cache line has been written to more than a MAX number of times without another processor writing to the cache line, the cache line is likely not to be ping-ponging between caches. In this case, the system moves the cache line into modified state 306 across transition 4B.

When the processor is in the shared-broadcast state 308, and if a the processor wants to write the cache line, and furthermore the cache line has been written to more than a MAX number of times without another processor writing the cache line, the system moves the cache line into shared-broadcast state 306 across transition 5A.

When the processor is in the shared-broadcast state 308 and the cache line is cast out of cache, the system moves the cache line into the invalid state as is indicated by transition 5B.

Note that a cache line that is being updated or otherwise accessed by multiple processors will tend to cycle through invalid state 302, shared-invalidate state 304, and modified state 306, which is a symptom of “ping-ponging” between caches. This ping-ponging can be prevented by moving the cache line into either owned-broadcast state 310 or shared-broadcast state 308.

Note that instead of moving the cache line automatically into owned-broadcast state 310 or shared-broadcast state 308, one embodiment of the present invention updates a counter each time the cache line can potentially be moved into one of these states. Only when this counter exceeds a threshold value, is the cache line moved into owned broadcast state 310 or shared-broadcast state 308. Using this counter ensures that the only cache line that is heavily contended for is moved the broadcast states.

Also note that cache controller 202 can be locked into the write-invalidate mode in a shared-memory multiprocessor system that includes caches that are not able to switch to the write-broadcast mode.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A method to facilitate cache coherence with adaptive write updates, comprising:
initializing a cache to operate using a write-invalidate protocol;
monitoring a dynamic behavior of the cache during program execution; and
switching the cache to operate using a write-broadcast protocol if the dynamic behavior indicates that better performance can be achieved using the write-broadcast protocol.

2. The method of claim 1, wherein monitoring the dynamic behavior of the cache involves monitoring the dynamic behavior of the cache on a cache-line by cache-line basis.

3. The method of claim 2, wherein switching to the write-broadcast protocol involves switching to the write-broadcast protocol on a cache-line by cache-line basis.

4. The method of claim 1, wherein monitoring the dynamic behavior of the cache involves maintaining a count for each cache line of the number of cache line invalidations the cache line has been subject to during program execution.

5. The method of claim 4, wherein if the number of cache line invalidations indicates that a given cache line is updated frequently, switching the cache line to operate under the write-broadcast protocol.

6. The method of claim 5, wherein if a given cache line is using the write-broadcast protocol and the number of cache line updates indicates that the given cache line is not being contended for by multiple processors, switching the given cache line back to the write-invalidate protocol.

7. The method of claim 4, wherein if the shared memory multiprocessor includes modules that are not able to switch to the write-broadcast protocol, the method further comprises locking the cache into the write-invalidate protocol.

8. The method of claim 1, wherein the write-invalidate protocol sends an invalidation message to other caches in a shared memory multiprocessor when a given cache line is updated in a local cache.

9. The method of claim 1, wherein the write-broadcast protocol broadcasts an update other caches in a shared memory multiprocessor when the given cache is updated in a local cache.

10. An apparatus to facilitate cache coherence with adaptive write updates, comprising:
an initializing mechanism configured to initialize a cache to a write-invalidate protocol;
an monitoring mechanism configured to monitor a dynamic behavior of the cache; and
a switching mechanism configured to switch the cache to a write-broadcast protocol if the dynamic behavior indicates that better performance can be achieved using the write-broadcast protocol.

11. The apparatus of claim 10, wherein monitoring the dynamic behavior of the cache involves monitoring the dynamic behavior of the cache on a cache-line by cache-line basis.

12. The apparatus of claim 11, wherein switching to the write-broadcast protocol involves switching to the write-broadcast protocol on a cache-line by cache-line basis.

13. The apparatus of claim 10, wherein monitoring the dynamic behavior of the cache involves maintaining a count of cache line invalidations initiated by each processor within a shared memory multiprocessor.

14. The apparatus of claim 13, wherein if the count of cache line invalidations indicates that a given cache line is updated frequently in different caches of the shared memory multiprocessor, switching the cache to the write-broadcast protocol.

15. The apparatus of claim 14, wherein if the given cache line is using the write-broadcast protocol and the count of cache line invalidations indicates that the given cache line is being invalidated in only one cache, switching the cache to the write-invalidate protocol.

16. The apparatus of claim 13, further comprising a locking mechanism configured to lock the cache into the write-invalidate protocol if the shared memory multiprocessor includes modules that are not able to switch to the write-broadcast protocol.

17. The apparatus of claim 10, wherein the write-invalidate protocol involves sending an invalidate message to other caches within a shared memory multiprocessor when a given cache is written to.

18. The apparatus of claim 10, wherein the write-broadcast protocol involves broadcasting a data update message to other caches within a shared memory multiprocessor when a given cache is written to.

19. A computing system that facilitates cache coherence with adaptive write updates, comprising:
a plurality of processors, wherein a processor within the plurality of processors includes a cache;
a shared memory;
a bus coupled between the plurality of processors and the shared memory, wherein the bus transports addresses and data between the shared memory and the plurality of processors
an initializing mechanism configured to initialize the cache to a write-invalidate protocol;
a monitoring mechanism configured to monitor a dynamic behavior of the cache; and
a switching mechanism configured to switch the cache to a write-broadcast protocol if the dynamic behavior indicates that better performance can be achieved using the write-broadcast protocol.

20. A means to facilitate cache coherence with adaptive write updates, comprising:
a means for initializing a cache to a write-invalidate protocol;
a means for monitoring a dynamic behavior of the cache; and
a means for switching the cache to a write-broadcast protocol if the dynamic behavior indicates that better performance can be achieved using the write-broadcast protocol.
